(19) United States
(12) Patent Application Publication
(10) Pub. No.: US 2005/0088641 A1
(43) Pub. Date: Apr. 28, 2005

(54) Testing method for rangefinders

(76) Inventors: Chih-Wei Hung, Taichung (TW); Peng-Fei Song, Taichung (TW); Pi-Yao Chien, Taichung (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/865,883

(22) Filed: Jun. 14, 2004

(30) Foreign Application Priority Data
Oct. 23, 2003 (TW) 92129483

(51) Int. Cl. G01C 3/08

(52) U.S. Cl. 356/4.02; 356/4.1; 356/4.01

(57) ABSTRACT

A testing method for rangefinders is described and saves developing time of a required rangefinder. The method sets a default parameter of a rangefinder for emitting pulses, emits the firing pulses toward a target using an emission module according to the parameter, receives reflected pulses from the target and straylight according to the parameter by an receiving module; generates S/N data of the received pulse and the straylight with a testing system, resets the parameter or changing some components with different feature if no target signal can be recognized from the S/N data and repeats steps 2 to 4 until a target signal is recognized from the S/N data; and configures the rangefinder with the default parameter or the substitute component with which the target signal can be recognized from the S/N data.

### FIELD OF THE INVENTION

The present invention relates to a testing method used in rangefinders, and more particularly, to a testing method that saves the developing time of laser rangefinders.

### BACKGROUND OF THE INVENTION

From ancient times to the present, distance estimation is always very important for humanity in daily life. From the measuring tape to the geometrical rangefinder, people are always searching for a faster and more accurate measuring tool and more efficient method for solving the problem of distant measurement.

Since conventional measuring tools, such as the geometrical rangefinder, need to be set up on a specific ground and operated by a person, errors and inaccuracy are inevitable.

Therefore,when laser rangefinders be invented and appear in the market, it's very popularly with people. Reference is made to FIG. 1, which illustrates the basic principle of the laser rangefinder 10. First, the laser rangefinder 10 emits a signal 102 of laser beam to the target 12 and records the emission time. The signal 102 possesses some certain pattern for ease of recognition. After the signal 102 arrives the target 12, an inverse reflected signal 104 is produced according to optical theorem. The laser rangefinder 10 receives the reflected signal 104 and records the reception time. The reception time minus the emission time is the transmission time of the whole transmission process. Since the velocity of light is 3×108 meters per second, the transmission time multiplied by the velocity of light and then divided by 2 is the distance between the laser rangefinder 10 and the target 12. However, even though the laser rangefinder can measure the distance quickly and precisely, the velocity of light is so great that it is complicated for the laser rangefinder to precisely estimate distance. Further, owing to the complexity of adjusting the laser rangefinder, laser rangefinders are always expensive and thus not popular with people.Besides, since laser rangefinders have a variety of applications, such as estimating distances, the physical property of the space being estimated, such as a water surface with high humidity, and other conditions using the principle of distance estimation with a laser beam, such as speed estimators used by police, the adjustment of emitted signals and received signals determines the quality of laser rangefinders. However, due to the shortage of integrated testing methods, only testing apparatus with individual estimating property can be chosen in accordance with the need in developing when producing current laser rangefinders. Such apparatus is expensive, inefficient and wastes time and effort. Hence, it has become important to set up a testing method that is flexible and can be used in every kind of laser rangefinder.

### SUMMARY OF THE INVENTION

An objective of the present invention is to provide a testing method for laser rangefinders in which every parameter of a laser rangefinder can be flexibly set to obtain the optimum value.

According to the aforementioned objectives, the present invention uses a testing system to test a rangefinder. The testing system comprises a central processing unit, a display unit, and a memory unit, and the rangefinder comprises an emission module, a receiving module, and an analog/digital converter. The parameters for emission times, emission power of the laser, and receiving threshold voltages are set, and an emission module emits firing pulses toward a target in accordance with the default parameters. After the target reflects the pulses, the receiving module receives and filters the reflected pulses and accompanying stray-light according to the preset receiving threshold voltages, and then generates an analog signal. The analog signal will be converted to a digital signal via an analog/digital converter and sent back to the testing system and saved in a memory unit. The central processing unit accesses and analyzes the data in the memory unit to obtain its signal/noise ratio (S/N), and converts the same into visual data for display on the display unit. User checks the visual data on the display unit, and judges if the S/N meets the ideal value. The S/N is usually shown as a logarithm, in which the higher the value, the bigger the difference of the strength between the signal and the noise, i.e. the strength of the signal is bigger. If the S/N is too low, the parameters can be reassigned or the components with better features are substituted until the rangefinder achieves an optimum S/N ratio.

Accordingly, the advantages of the present invention are as follows. First, the system collects and analyzes the original data of the laser rangefinder for different optical systems, emission voltages, threshold voltages for received signals, and the natural environment, and displays the signal/noise chart. Second, the system in the present invention can speed the testing process and the the parameters setting in the laser rangefinder to meet the requirements in every application.

The following will describe the present invention in detail with reference to the drawings.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates the basic principle of a conventional laser rangefinder;

FIG. 2 illustrates the system block diagram according to the embodiment of the present invention;

FIG. 3 illustrates the method flow diagram according to the embodiment of the present invention;

FIG. 4 illustrates the example of processing the receiving signal emitted three times;

FIG. 5 illustrates the schematics of accumulated showing up times/the distance according to the received signal;

FIG. 6 illustrates the S/N chart according to the received signal;

FIG. 7 illustrates an ideal schematics of accumulated showing up times/the distance; and

FIG. 8 illustrates an ideal S/N chart.

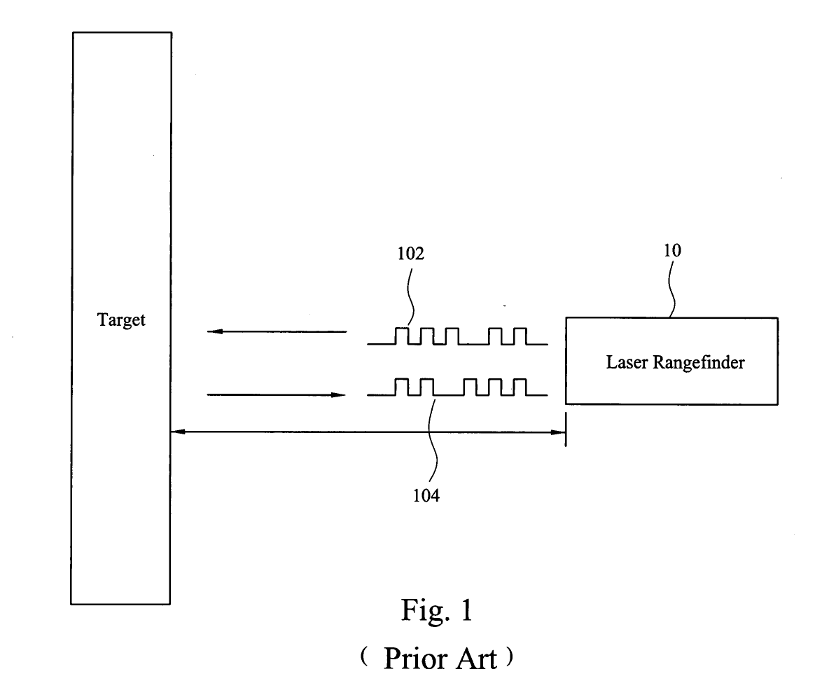

### DETAILED DESCRIPTION OF THE PREFERRED EMBODIMENT

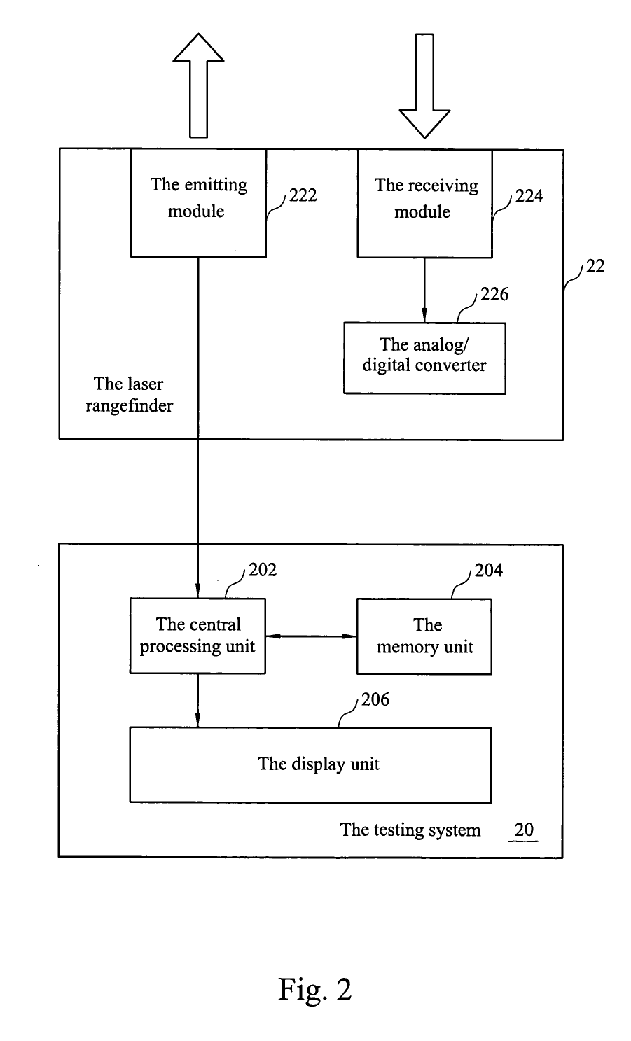

Reference is made to FIG. 2, which provides a block diagram of the present invention including the master units required in testing. The present invention uses a testing system 20 to control the motion of the laser rangefinder 22, to process the reflected signals received and convert them into graphical S/N data for display on the display unit 206. The testing system 20 mainly comprises the central processing unit 202, the memory unit 204, and the display unit 206; the laser rangefinder 22 mainly comprises the emission module 222, the receiving module 224, and the analog/digital (A/D) converter 226. The central processing unit 202 herein is, for example, a microprocessor, a micro controller, or any apparatus with operation ability. Further, the memory unit 204 herein is, for example, a memory, a hard disk or any storage apparatus, and the display unit 206 is, for example, a cathode ray tube monitor (CRT), a liquid crystal display (LCD), or any apparatus with graphical display function. The testing system 20 is any apparatus comprising these three units, such as a computer, a workstation, or a personal digital assistant (PDA). Further, as well known by those skilled in the art, the input/output interface and buses needed for the testing system will be configured respectively in accordance with different systems.

The aforementioned testing system 20 is mainly used to set flexibly the parameters of the laser rangefinder 22 to control the emission times and the power of the laser of the emission module 222 and the receiving threshold voltage of the receiving module 224 in the laser rangefinder 22. The testing system 20 also processes the reflected analog signals from the target received by the receiving module 224, converts them into digital signals via the analog/digital converter 226, then statistically analyzes the signals to S/N data and plots them in visual chart with the central processing unit 202, and finally outputs the same to the display unit 206 as reference for parameter adjustment by a user.

The aforementioned central processing unit 202 is mainly used to control the motion of the emission module 222, and perform the processing, analysis, and conversion of the received signals.

The aforementioned memory unit 204 is mainly used to save control programs and receive signals.

The aforementioned display unit 206 is mainly used to display the visual chart converted, analyzed, and plotted by the central processing unit 202.

The aforementioned emission modules 222 is connected to the central processing unit 202, and drives the laser to emit according to the control signals from the central processing unit 202.

The aforementioned receiving module 224 is connected to the analog/digital converter 226, and mainly used to receive the reflected signals from the target and straylight, and output an analog signal to the analog/digital converter 226.

The aforementioned analog/digital converter 226 is mainly used to receive the analog signal from the receiving module 224, and convert it into a digital signal.

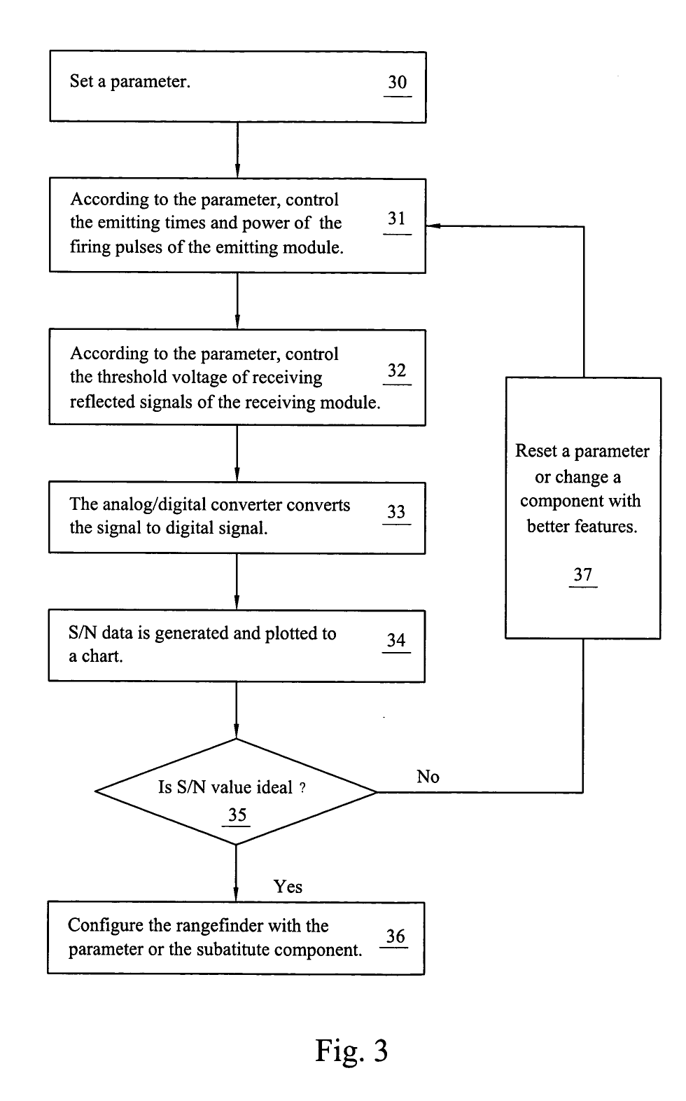

The following will describe the procedure of the present invention with reference to the flow diagram. Reference is made to FIG. 3 and FIG. 2. Steps are as follows.

First, the parameter of the testing system 20 (step 30) is predetermined to control the emission times and the power of the firing pulses and the receiving threshold voltage of the receiving module 224 in the laser rangefinder 22. Next, according to the parameter, the emission module 222 is commanded to emit a plurality of firing pulses toward a target (step 31). Meanwhile, according to the parameter, a receiving threshold voltage of the receiving module 224 to receive the reflected firing pulses from the target and stray-light is set (step 32), and an analog signal is output. Then, the analog signal is converted into a digital signal by the analog/digital converter 226 (step 33), and the digital signal is returned to the testing system 20 and saved in the memory unit 204. Afterwards, the central processing unit 202 accesses the digital signal. Since the digital signal not only contains the reflected firing pulses, but also may contain the background noise with a different signal level, the central processing unit 202 needs to analyze and sum up all the values, compare the value of every emission signal in turn, and conclude to plot the S/N distribution chart of the signal to recognize the real target signal (step 34).

The following examples describe the procedure of how the reflected digital signal from the target is analyzed and plotted in the S/N chart, and the timing and results of parameter adjustment.

### EXAMPLE 1

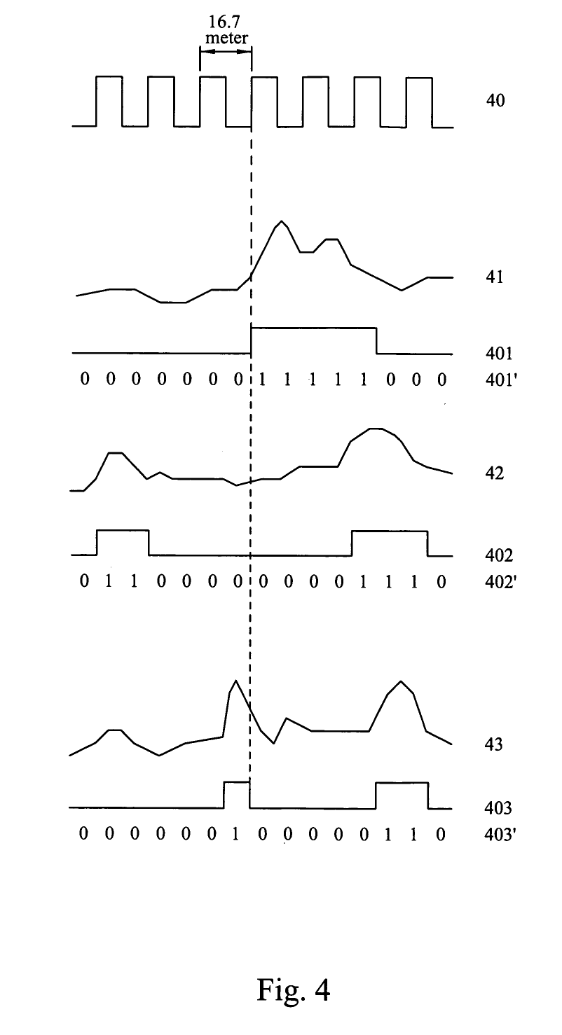

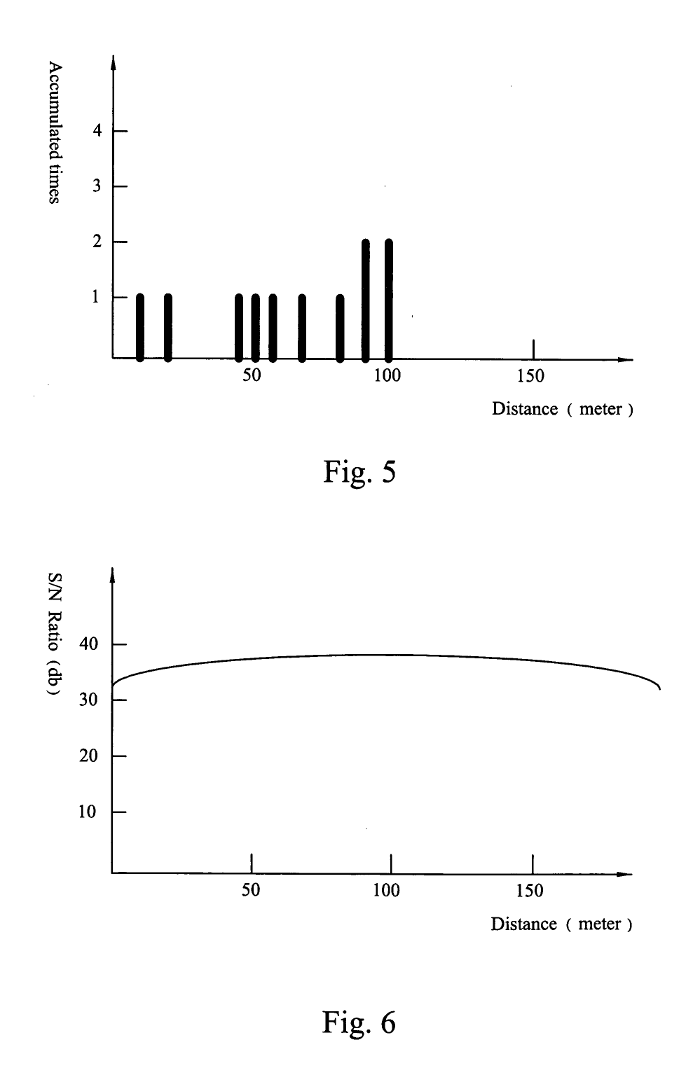

Reference is made to FIG. 4. If the predetermined emission time of the laser rangefinder 22 is three, and the inner clock signal is 40, the first reflected signal from the target received by the receiving module is 41 and the second and the third reflected signals from the target are 42 and 43, respectively. The signals 41, 42, and 43 are converted into the digital signals 401, 402, and 403, respectively, through the analog/digital converter 226 in accordance with the inner clock signal 40, and saved in the form of values in the memory unit 204 in order. The values are denoted 401′, 402′, and 403′ in order. At this moment, the central processing unit 202 computes the relative distance by multiplying the velocity of light by one half the time difference between the time of the emission module 222 emitting the pulse signal and the time of the receiving module 224 receiving the reflected signal. The digital signal 401, for example, when the signal level “1” first shows up, might be the reflected signal from the target. If 3 clock signal cycles have passed between emitting the signal and receiving the reflected signal, and the clock signal cycle is 0.11 microseconds, then the signal cycle is 0.11×3=0.33 microseconds, the time for the laser light to travel to the target and back one time. Therefore, the distance is time (0.33/2=0.167 microsecond) multiplied by the velocity of light (3×108 meters per second), which is 50 meters. All the possible distance of the targets of the digital signals 401, 402, and 403 can be derived in the same way. If the X-axis denotes the distance and the Y-axis denotes the accumulated showing up times, then the distribution will be as shown in FIG. 5. According to the ratio of the strength of the target signal (i.e. the strength of the signal 100 meter far) to the strength of the noise in every distance, and in the form of logarithm (db), a S/N chart in which the X-axis denotes the distance and the Y-axis denotes the strength ratio (db) as shown in FIG. 6 will be plotted and shown in the display unit 206, whereby users can distinguish the strength of the target signal from the background noise. It can be derived from FIG. 5 that due to the insufficient emission times of sampling, the distribution of S/N in FIG. 6 is too average to properly judge the target signal. Hence, the emission times needs to be reset (step 37).

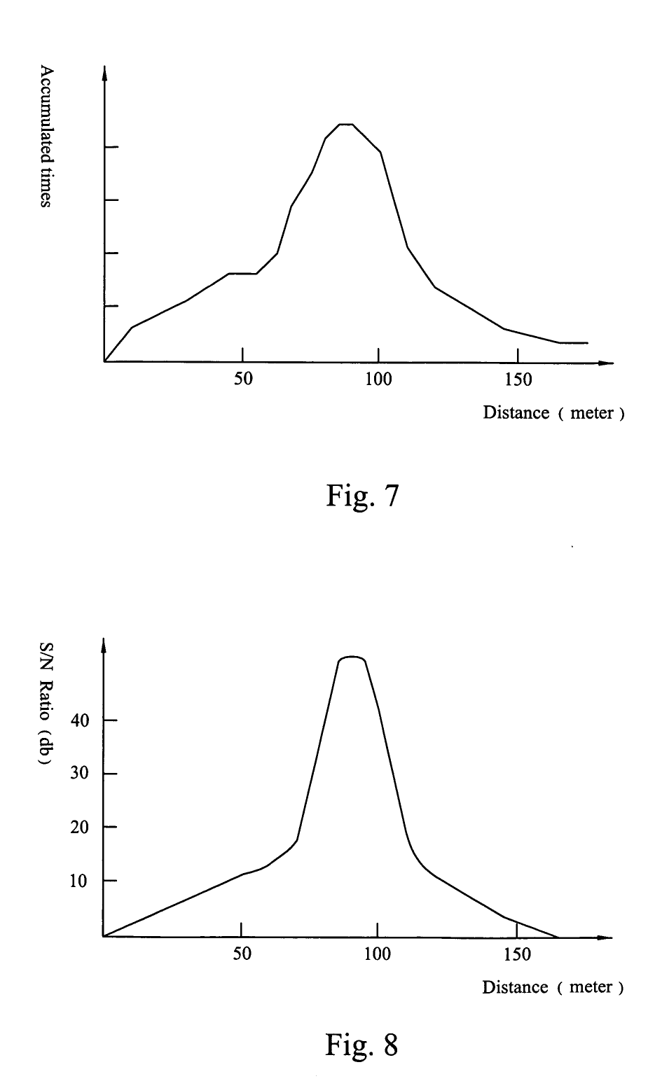

If the emission times is reset to 100 and steps 31 to 35 repeated to convert the reflected signal and compute the distance, a distribution chart in which the X-axis denotes the distance and the Y-axis denotes the accumulated showing up times as shown in FIG. 7 will be plotted. According to the ratio of the strength of the target signal (i.e. the strength of the signal 100 meter far) to the strength of the noise in every distance, and in the form of logarithm (db), a S/N chart in which the X-axis denotes the distance and the Y-axis denotes the strength ratio (db) as shown in FIG. 8 will be plotted and shown in the display unit 206. As shown in FIG. 8, it is an ideal S/N distribution chart, whereby users can clearly determine the real distance of the target. Users can store the setting of the emission times in the laser rangefinder 22 (step 36) and finish the procedure of the whole system. Furthermore, the correction of the emitting parameter includes not only the emission times, but also the emission power. If the ideal S/N distribution cannot be acquired after repeatedly resetting the emission times, users may try to adjust the emission power to meet the demand. Reference is made to example 2.

### EXAMPLE 2

The emission power of laser usually needs to be reduced to avoid excessive background noise when measuring a close target. On the contrary, the emission power of laser usually needs to be raised to increase the discrimination of the target when measuring the distant targets. Therefore, a failure to acquire the ideal S/N distribution after repeatedly resetting the emission times indicates the necessity of adjusting the emission power of the laser. At this time, the emission power needs to be reset (step 37) and steps 31 to 35 repeated to convert the reflected signal and compute the distance as in example 1. A S/N chart in which the X-axis denotes the distance and the Y-axis denotes the strength ratio of the signal/noise will be plotted and shown in the display unit 206. As shown in FIG. 8, it is an ideal S/N distribution chart, whereby users can clearly determine the distance of the target. Users can store the setting of the emission power in the laser rangefinder 22 (step 36) and finish the procedure of the whole system. However, if the ideal S/N distribution cannot be acquired after repeatedly resetting the emission times and the emission power, the receiving threshold voltage of the receiving module may need to be corrected. Reference is made to example 3.

### EXAMPLE 3

The receiving threshold voltage decides the least voltage of the receiving module to receive signals, and thus can filter out unnecessary noise. However, if the the target is too far away, the reflected signal may be so weak that the threshold voltage will filter it, and therefore, the receiving module cannot receive the reflected signal. At this time, the threshold voltage of the receiving module needs to be reset (step 37) and steps 31 to 35 repeated. Finally, the setting of the parameter is saved in the laser rangefinder 22. Moreover, the property of the components will also affect the ideal of the S/N chart. Hence, the choices of the components are necessary and important during the developing of the laser rangefinder. Reference is made to example 4.

### EXAMPLE 4

The components of the laser rangefinder comprise the emission module, the receiving module, and the analog/digital converter. If the power of the emission module, the receiving sensitivity of the receiving module, and the analyzing ability of the analog/digital converter are insufficient, the requirements will not be satisfied however the parameters are set. At this time, one or several components need to be changed (step 37) and steps 31 to 35 repeated. The component is installed in the laser rangefinder 22 to finish the whole procedure.

Hence, the advantages of the present invention are as follows. First, the system can collect and analyze the original data of the laser rangefinder in different optical systems, emission voltages, receiving voltages, receiving threshold voltages, and the natural environment, and display the signal/noise chart. Second, the system in the present invention can accelerate the testing and the setting of the parameters in the laser rangefinder to perform precision estimation.

As is understood by a person skilled in the art, the foregoing preferred embodiments of the present invention are illustrative of the present invention rather than limiting of the present invention. It is intended that various modifications and similar arrangements be covered within the spirit and scope of the appended claims, the scope of which should be accorded the broadest interpretation so as to encompass all such modifications and similar structures.

1. A testing method for rangefinders, comprising:
1) setting a default parameter of a rangefinder;
2) according to the default parameter, using an emission module to emit a plurality of firing pulses toward a target;
3) according to the default parameter, using a receiving module to receive the reflected pulses from the target and stray-light;
4) generating S/N data for the reflected pulses and the stray-light with a testing system;
5) resetting the default parameter or using a substitute component with better features if no target signal can be recognized from the S/N data and repeating steps 2 to 4 until a target signal is recognizable from the S/N data; and
6) configuring the rangefinder with the default parameter or installing the substitute component allowing the target signal recognition from the S/N data.

2. The testing method for rangefinders of claim 1, wherein the rangefinder is connected to the testing system.

3. The testing method for rangefinders of claim 1, further comprising:
A. after every emission of firing pulses, converting the reflected pulses and the stray-light received by the receiving module to a same stack value; and
B. aligning the stack value along the space axis in order to accumulate the S/N data.

4. The testing method for rangefinders of claim 1, wherein the testing system in step 4 comprises a central processing unit, a memory unit, and a display unit.

5. The testing method for rangefinders of claim 1, wherein the default parameter in step 1 comprises emission times, emission power, and threshold voltages of the receiving module.

6. The testing method for rangefinders of claim 1, wherein the substitute component in step 5 comprises the emission module, the receiving module, and an analog/digital converter.

7. The testing method for rangefinders of claim 4, wherein the central processing unit in the testing system is a microprocessor.

8. The testing method for rangefinders of claim 7, wherein the memory unit in the testing system comprises a memory, and a hard disk.

9. The testing method for rangefinders of claim 8, wherein the display unit in the testing system comprises a cathode ray tube monitor (CRT), and a liquid crystal display (LCD).

10. The testing method for rangefinders of claim 9, wherein the testing system comprises a computer, a workstation, and a personal digital assistant (PDA).

11. The testing method for rangefinders of claim 3, wherein step A comprises using an analog/digital converter to convert analog pulses and stray signals received by the receiving module to digital signals.

12. The testing method for rangefinders of claim 3, wherein step B comprises using a memory unit and a central processing unit wherein the memory unit saves reflected digital signals for the central processing unit to analyze to form the S/N data.
